(19) United States
(12) Patent Application Publication
(10) Pub. No.: US 2004/0057477 A1
(43) Pub. Date: Mar. 25, 2004

(54) Wavelength locking device

(75) Inventors: Alan Barron, Plano, TX (US); William Herrmann, Mesquite, TX (US); John McNeil, Ft. Collins, CO (US); Jury V. Vandyshev, Allentown, PA (US); Kou-Wei Wang, Orefield, PA (US)

Correspondence Address: HITT GAINES P.C., P.O. BOX 832570, RICHARDSON, TX, 75083, US

(73) Assignee: Agere Systems Inc., Allentown, PA

(21) Appl. No.: 10/253,627

(22) Filed: Sep. 24, 2002

(51) Int. Cl. H01S 3/098; H01S 3/13

(52) U.S. Cl. 372/32

(57) ABSTRACT

The present invention provides an optoelectronic device, a method of manufacture therefor and an optical communications system including the same. In an exemplary embodiment, the optoelectronic device includes a wavelength locking device that comprises a low reflector and optical filter. The optical filter an optical filter is located between the low reflector and an input end of the wavelength locking device. The optical filter and low reflector cooperate to lock an oscillation wavelength of a radiation source to a wavelength substantially determined by the optical filter.

### TECHNICAL FIELD OF THE INVENTION

The present invention is directed, in general, to an optoelectronic device and, more specifically, a wavelength locking device having an optical filter and a low reflector, a method of manufacture therefor, and an optical communications system including the same.

### BACKGROUND OF THE INVENTION

Electromagnetic radiation sources, such as lasers, used in optical communication systems, have stringent requirements. For instance, the wavelength locking range of a laser is an important parameter to control and stabilize. For many laser systems, including diode, solid-state, organic dye and gas lasers, the gain profile can be much wider than the axial-mode spacing of the laser cavity. Consequently, the laser may oscillate over an undesirably broad spectrum of multiple axial modes. Moreover, in certain applications, using semiconductor diode lasers for example, changes in environmental temperature, or operating current variations, may cause the laser to become unlocked or to lock at an undesired wavelength of light.

A number of techniques have been developed to reduce the spectral width of the axial modes. One well-known means of stabilizing the locking range involves coupling an external grated waveguide, such as a fiber Bragg grating (FBG), to a laser at its output facet. Fabry-Perot (F-P) lasers, for example, may have a broadband low reflectivity (LR) coating on the output facet that governs the wavelength where maximum internal reflectivity of the laser occurs, the so-called chip wavelength. Grated waveguides, such as FBGs, have their own narrow wavelength of maximum reflectivity, the so-called grating wavelength. When a FBG is coupled to the output end facet of a laser, the FBG may thus provide a narrow wavelength of optical feedback to the laser. So long as the chip and the grating wavelengths are substantially similar, the feedback can stimulate radiation thereby causing the laser to emit light, or lase, at the feedback wavelength of the grating, instead of the chip wavelength.

Such external grating stabilized laser packages however, remain problematic. They may still be relatively sensitive to temperature variations, for example, about 10 picometers per degree centigrade (pm/° C.). Moreover, because the LR coating may be sensitive to temperature, the chip wavelength may shift significantly away from the grating wavelength, causing the laser to lase at the chip wavelength. Under such circumstances the chip laser is said to be outside of the locking range of the grating waveguide. This may necessitate additional expenditures for active temperature stabilization. Moreover, the reflectivity and band shape for a grating, such as a FBG, are difficult to adjust. There are also additional expenses associated with producing an external grating, which may be fragile and difficult to fabricate. Finally, an external grating stabilized laser package may not be as compact as desired for certain semiconductor and telecommunication applications.

Previous efforts to resolve this problem have not lead to entirely satisfactory solutions. For example, the locking range of a FBG-stabilized laser may be increased by increasing the maximum reflectivity of the FBG, but at the cost of reduced output power. A grating internal to the laser chip, such as a diffraction grating, may be used to form a distributed feed back (DFB) laser to facilitate stabilization of the lasing wavelength, instead of an external FBG. However, such DFB lasers may have a greater temperature dependent shift than the temperature dependence of a laser coupled to an external grated waveguide. Moreover, DFB lasers are expensive to produce due to the added complexity of the design.

Accordingly, what is needed in the art is a compact wavelength locking device that does not experience previously encountered drawbacks.

### SUMMARY OF THE INVENTION

To address the above-discussed deficiencies of the prior art, the present invention provides a wavelength locking device. The device comprises a low reflector and an optical filter. The optical filter may be located between the low reflector and an input end of the wavelength locking device. The optical filter and low reflector cooperate to lock an oscillation wavelength of a radiation source to a wavelength substantially determined by the optical filter.

In another embodiment, the present invention provides a method of manufacturing a wavelength locking device having the above-described properties. The method comprises attaching a low reflector to a substrate and attaching an optical filter to the substrate between the low reflector and an input end of the wavelength locking device.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

Understanding the invention may be facilitated from the following detailed description and accompanying FIGUREs. In accordance with the standard practice in the optoelectronic industry, various features may not be drawn to scale. Rather, the dimensions of the various features may be arbitrarily increased or reduced for clarity of discussion. Reference is now made to the following descriptions taken in conjunction with the accompanying drawings, in which:

FIG. 1 illustrates a cross-sectional view of a wavelength locking device, which has been constructed in accordance with the principles of the present invention;

FIG. 2 illustrates a cross-sectional view of an alternative embodiment of a wavelength locking device;

FIG. 3 illustrates a cross-sectional view of another alternative embodiment of a wavelength locking device;

FIG. 4 illustrates a cross-sectional view of yet another embodiment of a wavelength locking device;

FIG. 5 illustrates a cross-sectional view of still another embodiment of a wavelength locking device;

FIG. 6 illustrates, by flow diagram, a method of manufacturing a wavelength locking device according to the present invention; and

FIG. 7 illustrates an optical communication system, which may form one environment where a wavelength locking device, similar to that shown in FIG. 1, may be included.

### DETAILED DESCRIPTION

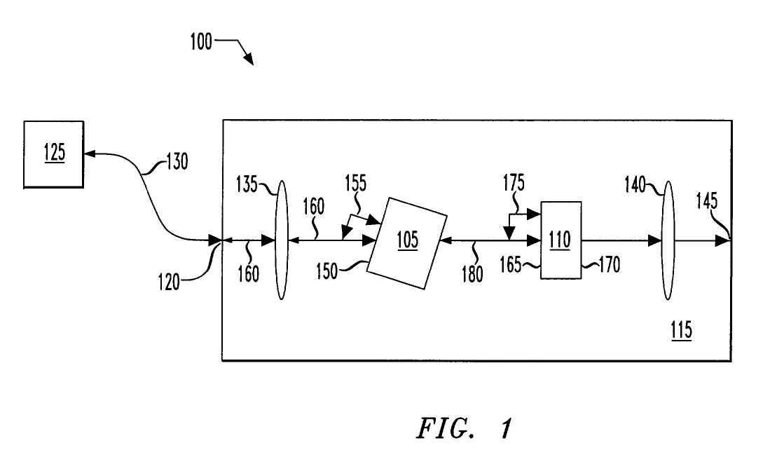

The present invention recognizes that the deficiencies associated with the use of grating-based locks can be avoided by replacing such gratings with a wavelength locking device comprising an optical filter and reflector. FIG. 1, illustrates a cross-sectional view of one embodiment of such a wavelength locking device 100. An optical filter 105 and low reflector 110 may be attached to any conventional substrate 115 conducive with the intended application, for example, a glass substrate for semiconductor or telecommunication applications. As illustrated, the optical filter 105 is located between the low reflector 110 and an input end 120 of the device 100. The optical filter 105 and low reflector 110 cooperate to lock an oscillation wavelength of a radiation source 125 to a wavelength substantially determined by the optical filter 105. The source 125 may be coupled to the device 100 via a connector 130, such as an optical fiber. In other embodiments, however, the source 125 could be integrated into the device 100 or other devices depicted herein. In certain preferred embodiments, the device 100 may further include one or more collimators 135, 140, located, respectively, between the optical filter 105 and the input end 120, and between the low reflector 110 and an output end 145 of the device. In certain preferred embodiments, the collimators 135, 140 comprise conventionally made laser collimator lens.

For purposes of the present invention, a radiation source 125 is defined as any device capable of emitting coherent electromagnetic energy. For example, in certain preferred embodiments, the radiation may be an optical wave comprising coherent light emitted by an optical laser source, such as a semiconductor laser. The optical wave may thus comprise a wavelength or band of wavelengths of light that oscillate at a particular frequency or band of frequencies characteristic of the radiation source. As noted above, the wavelength locker device of the present invention, such as device 100, may function to lock the oscillation wavelength of the radiation source to a narrow band of wavelengthssubstantially determined by the characteristics of the optical filter 105.

The term optical filter 105 as used herein refers to any material that allows only a targeted band of wavelengths of radiation to be transmitted or pass through the material, or only a band-pass of wavelengths to be reflected by the material. Preferably, the band or band-pass wavelength of the optical filter 105 has a low temperature dependence, as represented by a low temperature coefficient (i.e., the change in the center of the band or band-pass wavelength per unit change temperature). For example, in certain preferred embodiments, the temperature coefficient is less than about 10 pm/° C., and more preferably less than about 2 pm/° C., and even more preferably less than about 1 pm/° C.

In certain preferred embodiments, the optical filter 105 may include one or more thin film optical filters. The thin film optical filter may be comprised, for example, of alternating layers of two or more dielectric materials on a substrate, such as polished glass. Each thin film filter may thus transmit a certain band of wavelengths and reflect or absorb at all other wavelengths of radiation. In certain preferred embodiments, any number of thin film filters may be combined to form a more complex filter, such as a Wavelength Division Multiplexing (WDM) type filter. The fabrication of thin film optical filters using conventional thin film deposition techniques are well known to those of ordinary skill in the art. Commercial suppliers of such thin film filters include: Deposition Sciences Inc., (Santa Rosa, Calif.); Irdian Spectral Technologies Inc. (Ottawa, Canada); or Corning NetOptix Inc. (Marlborough, Mass.).

In certain advantageous embodiments, the optical filter 105 includes at least one surface 150 oriented at an angle 155 substantially non-perpendicular to an optical path 160 from the input end 120. Preferably, the angle 155 is sufficient to cause wavelengths of radiation not passed by the filter 105 to be reflected out of the field of view of the input end 120, thus avoiding feedback at these wavelengths. For example, in certain preferred embodiments, the angle 155 is less than about 88 degrees or greater than about 92 degrees. An additional advantage of orienting the filter 105 to such angles 155 is that the band-pass of the filter 105 is changed to a shorter wavelength. This provides an additional means of tuning the filter's 105 performance to optimize it for a particular application.

The term low reflector 110 as used herein refers to any material capable of reflecting a portion of light (i.e., at least about 0.1% reflectance) received from the optical filter 105, and transmitting the remaining portion to the output end 145. The extent of low reflectance may be tailored to be any amount desired for particular applications. In particular, low reflectance is important to achieve optimal levels of output power and performance of the source 125. Thus, the low reflector 110, in this, and any other embodiments described herein, is not a mirror. The term mirror as used herein refers to a surface that reflects substantially all the light (e.g., greater than about 90%) that it receives, and does not transmit light. In contrast, the low reflector 110 has a reflection coefficient of less than about 10 percent, and more preferably less than about 6, and transmits substantially all of the balance of light 145 that is not reflected. Moreover, the low reflector 110 preferably has a reflectance and transmittance that is spectrally flat. For example, the change in reflectance and transmittance is less than about 1% and more preferably less than about 0.1%, over a band width of at least about 1 nm, and more preferably at least about 10 nm.

The reflective coatings may be comprised of any conventional materials well known to those of ordinary skill in the art. The low reflector 110, for example, may comprise a glass plate or similar surface that has a desired amount of reflective coating on the surface 165 facing the optical filter 105. In certain preferred embodiments, the opposite side 170 of the low reflector 110 may include an anti-reflective coating comprised of any conventional materials well known to those of ordinary skill in the art.

In certain advantageous embodiments, the low reflector 110 is oriented at an angle 175 that is substantially perpendicular to an optical path 180 from the optical filter 105. The angle 175 is preferably sufficient to allow reflected radiation to be directed back to the source 125, as depicted by the leftward pointing arrows in FIG. 1 and subsequent figures, thus providing feedback only at wavelengths passed by the filter 105. For example, in certain preferred embodiments, the angle 175 is between about 88 and about 92 degrees, and more preferably between about 89 and about 91 degrees, and even more preferably between about 89.94 degrees and about 90.06 degrees.

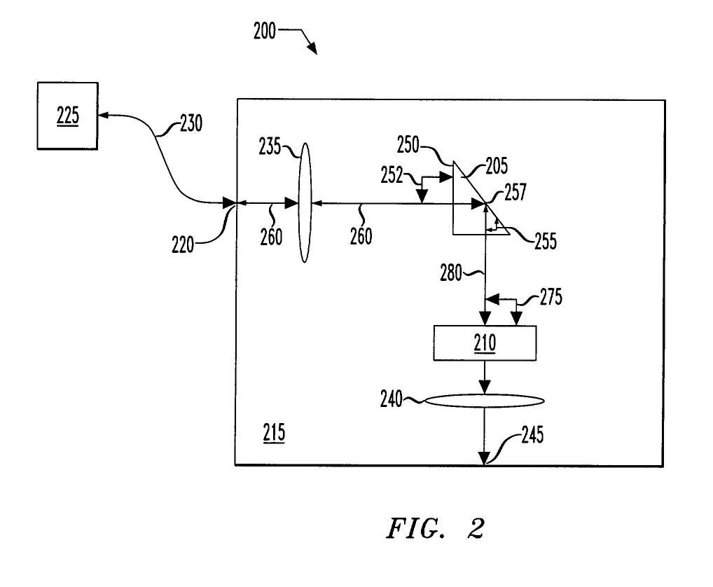

FIG. 2 illustrates an alternative embodiment of the wavelength locking device 200 that folds the optical path and thereby produces a smaller device package 200. The device components may include an analogous optical filter 205, low reflector 210, substrate 215, input end 220, collimators 235, 240, output end 245, and other above-described components similar to those depicted in FIG. 1. The optical filter's surface 250, however, is oriented at an angle 252 that is substantially perpendicular to the optical path 260 from the input end 220 to the optical filter 205. Additionally, the angle of orientation 255 of a reflective surface 257 in the filer 205 is configured so as to reflect radiation of the wavelengths defined by the optical filter 205 along an optical path 280. For example, the angle 255 may be between about 43 and about 47 degrees, and more preferably between about 44 degrees and about 46 degrees. In certain preferred embodiments, the optical filter 205 may comprise a band-pass filter, for example. In such a device 200, the low reflector 210 is preferably oriented at an angle 275 that is substantially perpendicular to the optical path 280 from the optical filter 205.

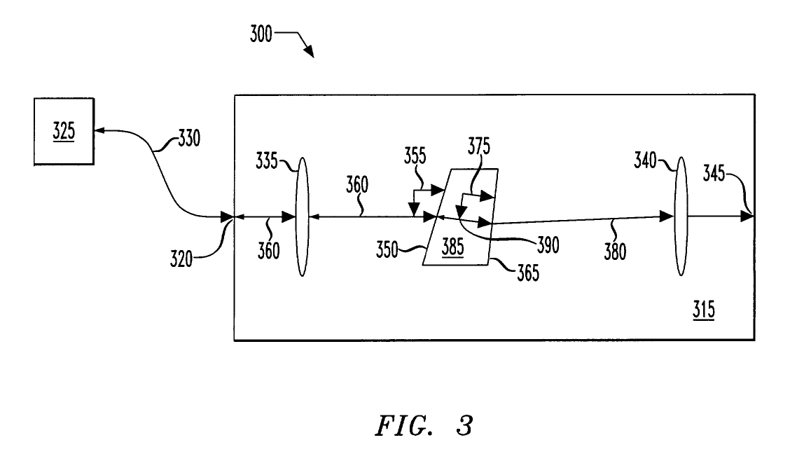

FIG. 3 illustrates another alternative embodiment of the wavelength locking device 300. Again, certain device components, including the substrate 315, input end 320, collimators 335, 340 and output end 345 are similar to those described above, with the exception that the optical filter 105 and low reflector 110 components shown in FIG. 1, form at least a portion of a monolithic, (i.e., single unit) component 385. Specifically, a first surface 350 of the monolithic component 385 comprises the optical filter and a second surface 365 of the monolithic component 385 comprises the low reflector. Analogous to that described for device 100, in certain preferred embodiments, the first surface 350 is oriented at a first angle 355 non-perpendicular to a first optical path 360 from the device's 300 input end 320. Additionally, the second surface 365 is oriented at a second angle 375 that is substantially perpendicular to a second optical path 390 from the first surface 350.

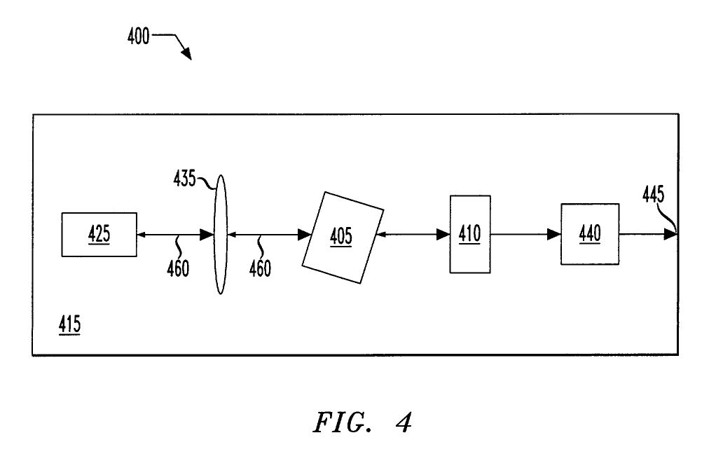

FIG. 4 illustrates yet another alternative embodiment of the wavelength locking device 400. Similar to the device depicted in FIG. 1, the device 400 may include an optical filter 405, low reflector 410, substrate 415, collimators 435, 440, output end 445, and other above-described embodiments. In certain embodiments analogous to the device 300 shown in FIG. 3, the device 400 may include a monolith component (not shown), similar to that described for device 300, instead of the separate optical filter 405 and low reflector 410 components. In addition, the device 400 includes a radiation source 425 attached to the substrate 415 that provides input to the optical filter 405 along an optical path 460. The device 400 may further include a first collimator 435, attached to the substrate 415 between the optical filter 405 and source 425. The device 400 may also include a second collimator 440 attached to the substrate 415 between the low reflector 410 and the output end 445 of the device 400. In certain preferred embodiments, the second collimator 440 may comprise a fiber collimator.

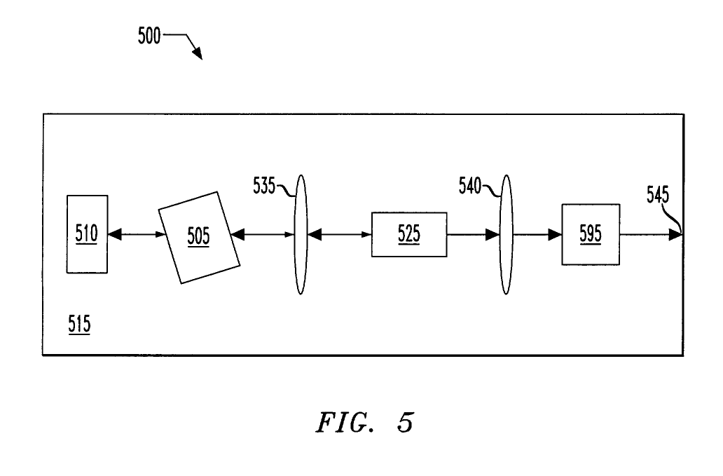

FIG. 5 illustrates still another alternative embodiment of the wavelength locking device 500. Similar to the above described devices, the device 500 may include an optical filter 505, low reflector 510, substrate 515, collimators 535, 540, output end 545, and other above-described embodiments, such as an alternative monolith component as discussed above. In addition, the device 500 includes a radiation source 525 attached to the substrate 515 and providing input to the optical filter 505. The device 500 may further include a first collimator 535 attached to the substrate 515 between the optical filter 505 and the source 525. A second collimator 540 may also be attached between the source 525 and the output end 545 of the device 500. In certain preferred embodiments, the collimators 535, 545 may comprise laser collimators. In yet other embodiments, the device 500 may further include a fiber collimator 595 attached to the substrate 515, between the second collimator 540 and the output end 545.

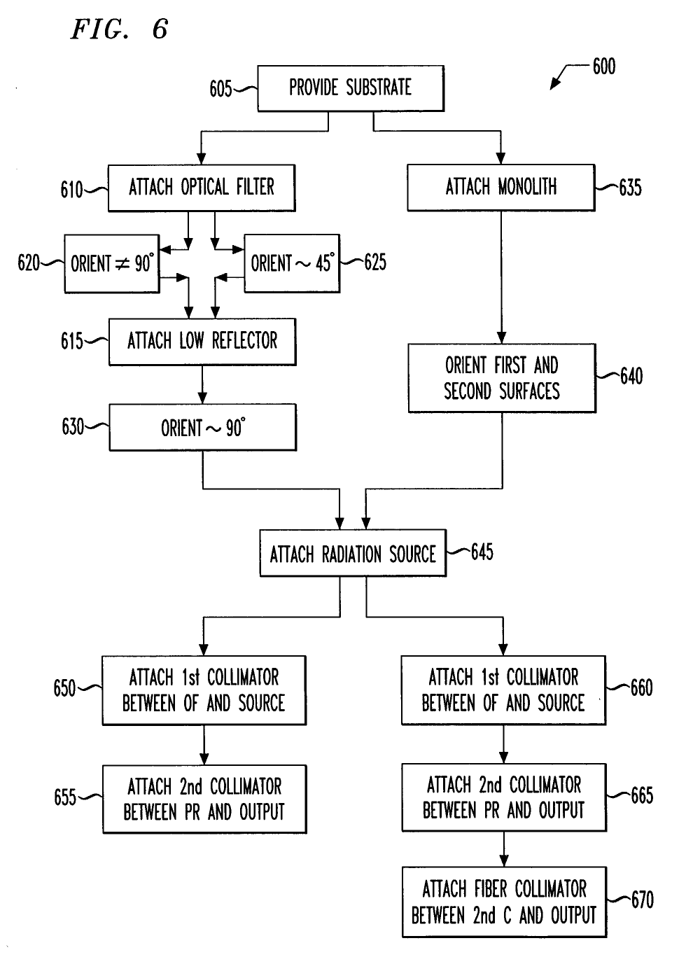

FIG. 6, illustrates, by flow diagram, another aspect of the present invention, a method 600 of manufacturing a wavelength locking device, similar to the devices illustrated in FIGS. 1-5. The method 600, may comprise providing a substrate in step 605. This may be followed by a step 610 of attaching an optical filter to the substrate and a step 615 of attaching a low reflector to the substrate. Step 615 further includes attaching the optical filter between the low reflector and an input end of the wavelength locking device. As discussed above, the low reflector and optical filter cooperate to lock an oscillation wavelength of a radiation source to a wavelength substantially determined by the optical filter.

Attaching the optical filter 610 may further include a step 620 of orienting a surface of the optical filter to an angle substantially non-perpendicular to a first optical path from the input end. Alternatively, for the manufacture of devices analogous to that depicted in FIG. 2, the optical filter may be oriented in a step 625 an angle so as to reflect radiation only of certain wavelengths defined by an optical filter along an optical path that is substantially perpendicular to the optical path from the input end to the optical filter. Attaching the low reflector 615 may further include a step 630 of orienting a surface of the low reflector to an angle substantially perpendicular to an optical path from the optical filter.

In certain alternative embodiments, the steps 610 and 615 of attaching the low reflector and optical filter, respectively, may be achieved by a single step 635 of attaching a monolithic component to the substrate. As depicted in FIG. 3, for such devices 300, a first surface of the monolithic component comprises the optical filter and a second surface of the monolithic component comprises the low reflector. The step 635 of attaching the monolithic component may further include a step 640 of orienting a first and second surface of the monolithic component to angles substantially non-perpendicular and perpendicular to a first and second optical path, respectively, analogous to steps 620 and 625 described above.

Yet other alternative embodiments, such as the manufacture of devices shown in FIGS. 4 and 5 for example, may further include a step 645 of attaching a radiation source to the substrate. Certain embodiments, such as the manufacture of the device 400 shown in FIG. 4 for example, may further include a step 650 of attaching a first collimator to the substrate between the optical filter (OF) and the source. These embodiments may also include a step 655 of attaching a second collimator to the substrate between the low reflector (PR) and an output end of the wavelength locking device. And, in certain preferred embodiments, step 655 may comprise attaching a fiber collimator.

Alternative advantageous embodiments, such as the manufacture of the device 500 shown in FIG. 5 for example, may further include a step 660 of attaching a first collimator to the substrate between the source and the optical filter. Such embodiments may further include a step 665 of attaching a second collimator between the source and an output end of the wavelength locking device. These embodiments may further include a step 670 of attaching a fiber collimator between the second collimator (C) and the output end.

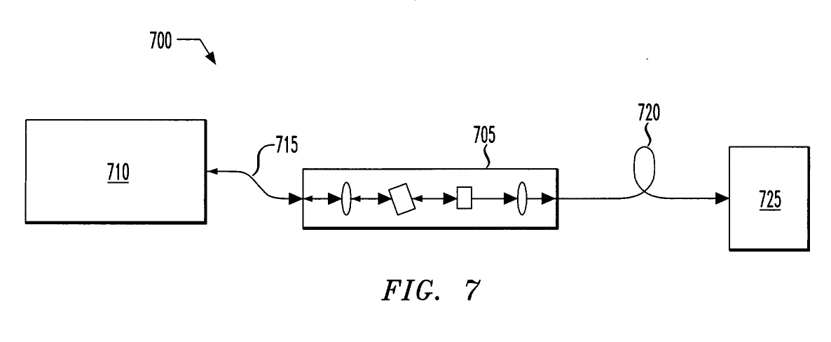

FIG. 7, illustrated yet another embodiment of the present invention, an optical communication system 700, which may form one environment where a wavelength locking device 705, such as the device 100 shown in FIG. 1 for example, may be included. Analogous to the device shown in FIG. 1, and as described in detail above, the wavelength locking device 705, includes a low reflector 105 and optical filter 110 and other optional components as discussed above and illustrated in FIG. 1. However, all other alternative and preferred embodiments described in the context of the device 100, shown in FIG. 1, or other devices discussed above may be also applied to the device 705 incorporated into the optical communication system 700.

The optical communication system 700 may include a radiation source 710 and an optical waveguide 715 that couples the radiation source 710 to an input end 120 (illustrated in FIG. 1) of the wavelength locking device 705. The radiation source 710, may comprise a number of different devices, however, in an exemplary embodiment the source device 710 comprises an optical signal source, such as a semiconductor diode laser. Such devices may include group III-V based device, for example an indium phosphide/indium gallium arsenide phosphide (InP/InGaAsP) based device, a gallium arsenide (GaAs) based device, an aluminum gallium arsenide (AlGaAs) based device, or another group III-V based device. Even though the present invention is discussed in the context of a group III-V based device, it should be understood that the present invention is not limited to group III-V compounds and that other compounds located outside groups III-V may be used.

The system 700 may also include an optical waveguide 720 coupling the wavelength locking device 705 to a receiver 725. The optical communication system 700, however, is not limited to merely the devices previously mentioned. For example, the optical communication system 700 may further include various photodetectors, optical combiners and optical amplifiers configured in a fashion well known to those of ordinary skill in the art.

Although the present invention has been described in detail, those skilled in the art should understand that they can make various changes, substitutions and alterations herein without departing from the spirit and scope of the invention.

What is claimed is:

1. A wavelength locking device, comprising:
a low reflector; and
an optical filter located between said low reflector and an input end of said wavelength locking device, said optical filter and said low reflector cooperating to lock an oscillation wavelength of a radiation source to a wavelength substantially determined by said optical filter.

2. The wavelength locking device as recited in claim 1, wherein said optical filter further includes a surface oriented at an angle substantially non-perpendicular to an optical path from said input end.

3. The wavelength locking device as recited in claim 1, wherein said low reflector is oriented at an angle that is substantially perpendicular to an optical path from said optical filter.

4. The wavelength locking device as recited in claim 1, wherein said optical filter and said low reflector form a portion of a monolithic component wherein a first surface of said monolithic component comprises said optical filter and a second surface of said monolithic component comprises said low reflector.

5. The wavelength locking device as recited in claim 4, wherein said first surface is oriented at a first angle non-perpendicular to a first optical path from said input end and said second surface is oriented at a second angle that is substantially perpendicular to a second optical path received from said first surface.

6. The wavelength locking device as recited in claim 5, wherein said first angle is less than about 88 degrees or greater than about 92 degrees.

7. The wavelength locking device as recited in claim 1, wherein said low reflector has a reflection coefficient of less than 10 percent.

8. The wavelength locking device as recited in claim 1, wherein said low reflector has a reflection coefficient of less than 6 percent.

9. The wavelength locking device as recited in claim 1, wherein said low reflector has a change in reflectance and transmittance of less than about 1% over a band width of about 10 nm.

10. The wavelength locking device as recited in claim 1, wherein said optical filter comprises a thin film filter.

11. The wavelength locking device as recited in claim 1, wherein said optical filter has a temperature coefficient of less than about 10 picometers/° C.

12. A method of manufacturing a wavelength locking device, comprising:
attaching a low reflector to a substrate; and
attaching an optical filter to said substrate between said low reflector and an input end of said wavelength locking device, said optical filter and said low reflector cooperating to lock an oscillation wavelength of a radiation source to a wavelength substantially determined by said optical filter.

13. The method as recited in claim 12 wherein said attaching said optical filter further includes orienting a surface of said optical filter to an angle substantially non-perpendicular to a first optical path from said input end.

14. The method as recited in claim 12 wherein said attaching said low reflector further includes orienting a surface of said low reflector to an angle substantially perpendicular to an optical path from said optical filter.

15. The method as recited in claim 12 further including attaching a monolithic component to said substrate wherein a first surface of said monolithic component comprises said optical filter and a second surface of said monolithic component comprises said low reflector.

16. The method as recited in claim 12 further including attaching a radiation source to said substrate.

17. The method as recited in claim 16 further including attaching a first collimator to said substrate between said optical filter and said source, and attaching a second collimator to said substrate between said low reflector and an output end of said wavelength locking device.

18. The method as recited in claim 17 wherein said second collimator comprises a fiber collimator.

19. The method as recited in claim 16 further including attaching a first collimator to said substrate between said source and said optical filter and attaching a second collimator between said source and an output end of said wavelength locking device.

20. The method as recited in claim 19 further including attaching a fiber collimator between said second collimator and said output end.
